(19) United States
(12) Patent Application Publication
(10) Pub. No.: US 2026/0277947 A1
(43) Pub. Date: Sep. 17, 2026

(54) SYSTEMS AND METHODS FOR AN AGENTIC FRAMEWORK

(71) Applicant: Kinaxis Inc., Ottawa (CA)

(72) Inventors: Ryan Christopher McCluskey, Ottawa (CA); Christopher Burt, Ottawa (CA); Phi Hung Tran, Ottawa (CA); Olivia Margot Perryman, Ottawa (CA)

(73) Assignee: Kinaxis Inc., Ottawa (CA)

(21) Appl. No.: 19/567,437

(22) Filed: Mar. 16, 2026

Related U.S. Application Data
(60) Provisional application No. 63/771,741, filed on Mar. 14, 2025.

(51) Int. Cl. G06F 16/3329; G06F 18/21

(52) U.S. Cl. CPC G06F 16/3329; G06F 18/217

(57) ABSTRACT

Systems and methods disclosed herein provide an automation framework that allows planners to use natural language to explain how they solve problems that they have encountered in the past. This results in an AI agent, conditioned on the instructions provided by a planner. This allows the supply chain management software to recognize problems, produce new scenarios where possible solutions are displayed, and asks the planner to verify which solution is most adequate.

This application claims priority on U.S. Ser. No. 63/771,741 filed on Mar. 14, 2025, which is incorporated herein in its entirety, by reference.

### BACKGROUND

Modern supply chain planning systems are complex, highly configurable environments that support a wide range of planning activities, including demand forecasting, inventory optimization, production scheduling, and resource allocation. These systems typically rely on a combination of heuristic algorithms, optimization models, and user-driven workflows to manage the intricate interdependencies between supply and demand. While such systems provide powerful tools for modeling and solving supply chain problems, they often fall short in capturing and reusing the implicit knowledge and decision-making patterns of human planners. This limitation is particularly evident in scenarios where planners perform repetitive tasks or apply domain-specific heuristics that are not encoded within the system.

Current approaches to supply chain planning emphasize automation through rule-based systems, machine learning models, and optimization engines. These methods are effective in handling well-defined problems with structured inputs and outputs. However, they are less capable of representing the nuanced, context-dependent reasoning that human planners employ when navigating ambiguous or semi-structured planning scenarios. As a result, planners frequently find themselves manually executing similar steps across different planning cycles, leading to inefficiencies and a lack of knowledge retention within the system.

Several existing systems attempt to enhance planning efficiency by integrating external data sources, improving visualization capabilities, or optimizing resource allocation. While these approaches contribute to better performance in specific areas, they do not address the fundamental challenge of capturing and reusing the procedural knowledge embedded in human planning workflows. The inability to model and replicate the decision-making logic of experienced planners limits the scalability and adaptability of supply chain planning systems, particularly in dynamic or high-variability environments.

This gap in functionality leads to a significant underutilization of human expertise. Planners are often required to re-express the same logic repeatedly, rather than focusing on higher-level strategic decisions. The absence of a mechanism to encode and reuse this knowledge results in redundant effort, inconsistent outcomes, and a reduced capacity for system learning and improvement over time. Addressing this issue requires a more sophisticated approach that bridges the gap between human decision-making and automated planning systems.

### BRIEF SUMMARY

Systems and methods disclosed herein provide an automation framework that allows planners to use natural language to explain how they solve problems that they have encountered in the past. This results in an AI agent (hereafter referred to as “agent”), conditioned on the instructions provided by a planner. This allows the supply chain management software to recognize problems, produce new scenarios where possible solutions are displayed, and asks the planner to verify which solution is most adequate.

The disclosed system introduces a novel approach to integrating human expertise into supply chain automation by enabling the iterative execution of tools with structured input and output, which is then used to refine the processing of instructions by a Large Language Model (LLM). This iterative feedback mechanism allows for dynamic adaptation of the solution path based on real-time outputs, improving the accuracy and relevance of the generated solutions. Unlike conventional systems that rely on static rule sets or predefined workflows, the disclosed framework continuously updates the model's understanding through structured data exchange, thereby enhancing decision-making precision and reducing manual intervention.

Additionally, the system's use of reusable resources such as workbooks, dashboards, and tools within an agent-based architecture enables greater flexibility and scalability in handling complex supply chain scenarios. An orchestration layer further enhances this by allowing multiple agents to collaborate in parallel or sequence, based on contextual and predefined parameters. This modular and extensible design supports the integration of domain-specific functions alongside generic data manipulation capabilities, enabling a more comprehensive and adaptable solution. Inclusion of chat-based interaction with a planner ensures that human oversight remains an integral part of the decision-making process, allowing for real-time validation and refinement of proposed solutions. These features collectively address limitations in prior systems by enabling more intelligent, context-aware automation that leverages both human insight and machine processing.

In one aspect, a computing apparatus is provided that includes a processor. The computing apparatus also includes a memory storing a first set of instructions that, when executed by the processor, configure the apparatus to: maintain an agent definition including a second set of instructions authored by a user and authorization to access a set of resources each having a respective schema defining input and output; receive a prompt indicative of a planning problem; generate, using a Large Language Model (LLM) conditioned on the prompt, the second set of instructions, and the schemas, an action specification that identifies at least one authorized resource and corresponding input for the at least one authorized resource; cause execution of the at least one authorized resource with the input to obtain output; update, based on the output, context provided to the LLM to generate a subsequent action specification until a completion condition is satisfied; and output, for presentation to the user, a proposed resolution of the planning problem derived from at least one said output.

The computing apparatus may also include where the second set of instructions include natural-language instructions. The computing apparatus may also include where the resources include software tools selected from a repository. The computing apparatus may also include where the schema for each resource is version controlled in a database. The computing apparatus may also include where the first set of instructions further configure the apparatus to receive user feedback via a graphical user interface and updating the agent definition based on the feedback. The computing apparatus may also include where the action specification includes chain multiple resources together in sequence or in parallel. The computing apparatus may also include where the agent includes an orchestration agent that delegates tasks to one or more worker agents and receives outputs from the worker agents to generate the proposed resolution. Other technical features may be readily apparent to one skilled in the art from the following figures, descriptions, and claims.

In one aspect, a non-transitory computer-readable storage medium s provided, the computer-readable storage medium including a first set of instructions that when executed by a computer, cause the computer to: maintain an agent definition including instructions authored by a user and authorization to access a set of resources each having a respective schema defining input and output; receive a prompt indicative of a planning problem; generate, using a Large Language Model (LLM) conditioned on the prompt, the second set of instructions, and the schemas, an action specification that identifies at least one authorized resource and corresponding input for the at least one authorized resource; cause execution of the at least one authorized resource with the input to obtain output; update, based on the output, context provided to the LLM to generate a subsequent action specification until a completion condition is satisfied; and output, for presentation to the user, a proposed resolution of the planning problem derived from at least one said output.

The computer-readable storage medium may also include where the second set of instructions include natural-language instructions. The computer-readable storage medium may also include where the resources include software tools selected from a repository. The computer-readable storage medium may also include where the schema for each resource is version controlled in a database. The computer-readable storage medium may also include where the first set of instructions further configure the computer to receive user feedback via a graphical user interface and updating the agent definition based on the feedback. The computer-readable storage medium may also include where the action specification includes chain multiple resources together in sequence or in parallel. The computer-readable storage medium may also include where the agent includes an orchestration agent that delegates tasks to one or more worker agents and receives outputs from the worker agents to generate the proposed resolution. Other technical features may be readily apparent to one skilled in the art from the following figures, descriptions, and claims.

In one aspect, a computer-implemented method is provided includes: maintaining an agent definition including instructions authored by a user and authorization to access a set of resources each having a respective schema defining input and output; receiving a prompt indicative of a planning problem; generating, using a Large Language Model (LLM) conditioned on the prompt, the instructions, and the schemas, an action specification that identifies at least one authorized resource and corresponding input for the at least one authorized resource; causing execution of the at least one authorized resource with the input to obtain output; updating, based on the output, context provided to the LLM to generate a subsequent action specification until a completion condition is satisfied; and outputting, for presentation to the user, a proposed resolution of the planning problem derived from at least one said output.

The computer-implemented method may also include where the instructions include natural-language instructions. The computer-implemented method may also include where the resources include software tools selected from a repository. The computer-implemented method may also include where the schema for each resource is version controlled in a database. The computer-implemented method may also include further includes receiving user feedback via a graphical user interface and updating the agent definition based on the feedback. The computer-implemented method may also include where the action specification includes chaining multiple resources together in sequence or in parallel. The method may also include where the agent includes an orchestration agent that delegates tasks to one or more worker agents and receives outputs from the worker agents to generate the proposed resolution. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for an agentic framework, in accordance with one embodiment.

FIG. 2 illustrates a system architecture diagram in accordance with one embodiment.

FIG. 3 illustrates a block diagram for constructing an agent, in accordance with one embodiment.

FIG. 4 illustrates a block diagram in accordance with one embodiment.

FIG. 5 illustrates a block diagram of a workflow for an agent, in accordance with one embodiment.

FIG. 6 illustrates an orchestration layer in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

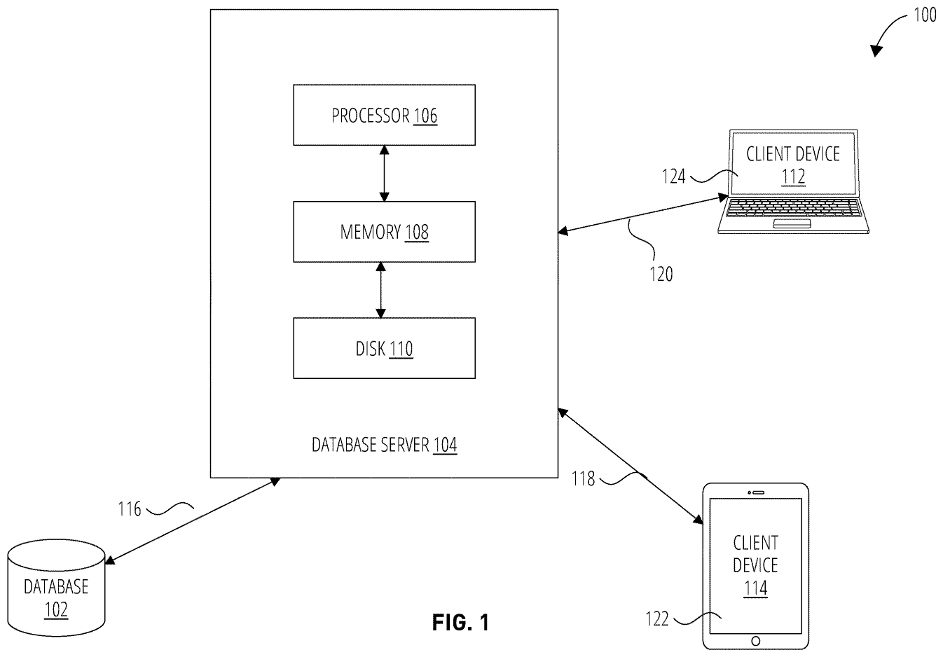

FIG. 1 illustrates an example of a system 100 for an agentic framework, in accordance with one embodiment.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also include a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

In the present disclosure, the terms “process” and “algorithm” are used interchangeably, and may refer to a set of steps performed in relation to an in-memory database, such as a versioned database. As referred to herein, for example, a deterministic process may be considered to be equivalent to a deterministic algorithm. A deterministic algorithm always produces the same output given a particular input. For example, an algorithm that always returns an output of Y with an input of X is deterministic. So, every time there is an input of X, it is known that the answer is Y. The result does not have to be unique, for example an input of Q can also return an output of Y, just deterministic. For a deterministic algorithm, once the input is known, the answer or output is already known, and it is not necessary to send the input to the algorithm at all.

In some implementations, a server memory may store an in-memory database as well as calculated results from processes or algorithms that are executed in relation to contents of the in-memory database. In some implementations, the calculated results may include about half of the server memory.

Reference to “in-memory” storage may refer to a server memory associated with database server 104, which may include memory 108 and/or database 102. Reference to “on-disk” storage may refer to disk 110 and/or other disks, for example disks associated with cloud storage.

In known approaches, both data (e.g. a versioned database) and calculations (e.g. calculated results) are stored in-memory. Such an approach is fast but also expensive. There is also a drawback that calculated results stored in-memory do not persist to disk when the server is restarted. The first time a calculation is performed, not only do all of the records need to be in-memory, but also the calculation structures must be built up in memory.

Embodiments of the present disclosure save memory and improve performance. Embodiments of the present disclosure avoid the time required to re-calculate the results, even the first time after server startup. Servers may have complicated invalidation rules. Even if something is stored in-memory, if the database changes, the results may be incorrect. Analytics results may also be lost from memory if the server detects that it is running out of memory. Embodiments of the present disclosure seek to solve one or more problems associated with known approaches, including wasted time and resources spent recalculating results.

A deterministic process as referred to herein may include an embedded algorithm, such as a supply chain algorithm used to analyze or calculate results based on an in-memory versioned database. An embedded algorithm may be implemented as a TypeScript algorithm. A deterministic process may include a core algorithm the results of which may not be serializable, for example if they are in-memory C++ objects that refer to other memories and other pointers.

Embodiments of the present disclosure may establish two tiers of storage, where the system may promote or demote a result. According to known approaches, some databases only exist in-memory, or only on-disk. Embodiments of the present disclosure provide a method of demoting content from in-memory to on-disk, or promoting content from on-disk to in-memory, for example in response to a server command or indication. If a result is not previously calculated, it can go from nowhere to in-memory or on-disk. In-memory is typically one tier, but on-disk can be one or more tiers. Embodiments of the present disclosure may be configured to provide an n-tier solution, for example where cloud storage provides different types of disks with different speeds of access, and the system may promote/demote to faster or slower disks in different on-disk tiers. Promoting/demoting refers to moving the results around, and is with respect to speed of access to the memory or disk(s).

Systems and methods disclosed herein provide an automation framework that allows planners to use natural language to explain how they solve problems that they have encountered in the past. This results in an agent, conditioned on the instructions provided by a planner. This allows supply chain management software to recognize problems, produce new scenarios where possible solutions are displayed, and asks the planner to verify which solution is most adequate.

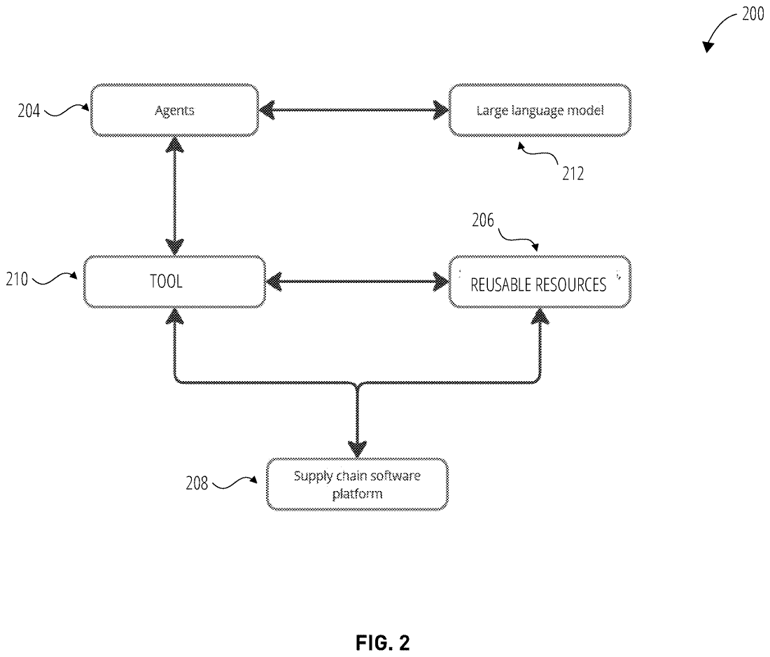

FIG. 2 illustrates a high-level system architecture diagram 200 in accordance with one embodiment.

Systems and methods disclosed herein may include the following elements:

A graphical user interface to build components of an agent 204, starting from templates or from scratch.

Reusable resources 206 that a planner has authored, to interact with a supply chain management software platform 208. Examples of a reusable resource 206 includes workbooks, dashboards and customizable tools. Reusable resources promote consistency and efficiency by allowing planners to reuse proven solutions and tailor tools to their needs. Workbooks and dashboards can be shared or version-controlled across teams as follows. These resources are version controlled in a database so they support check-in/check-out, restore previous version, comparing differences between versions, and so forth. They can also be shared with users/groups using different permission models (for example: view/modify).

New tools can be created and customized as follows. All resources have an authoring experience in the UI (for example, script is a code editor to write the JavaScript, dashboard is a WYSIWYG builder UI, and so forth). In addition, these resources can be exported or integrated with external systems as follows. They can be packaged and imported/exported between systems. They can also be licensed so that they cannot be used unless a license key has been purchased. Also, the agents are also resources in the system; version control and all of these features mentioned above, also apply to agents.

A reusable resource called a tool 210. Examples include tools prepackaged with the automation framework that allow the agent 204 to interact with the supply chain management software platform 208. In addition to prepackaged tools, examples also include customizable tools that allow planners with the requisite expertise to build their own library of tools that can be used by the agent. This can include domain-specific, generic (worksheet manipulation), and action-oriented tools.

A large language model 212 to parse instructions, to define input used for different resources, and to analyze outputs of resources. LLM integration leverages advanced NLP capabilities to understand and generate human-like responses, improving accuracy and usability. Examples of large language model used include enterprise LLMs such as Google Gemini™ and OpenAI GPT™. Ambiguous or incomplete instructions from planners are addressed since the agent has system guardrails in their instructions that tell it to clarify ambiguous/unclear/incomplete tasks with the user before taking action. There are safeguards in place to prevent errors or biases in the model's output. For example, a robust confirmation system can be put in place that blocks the agent from taking certain actions like running a script until the user manually clicks a button in the application. Databases also support Scenarios which allow the agent to make data changes in a sandbox that can then be manually reviewed/committed to the real data by planners.

A prompt to start the agent's process of solving a solution.

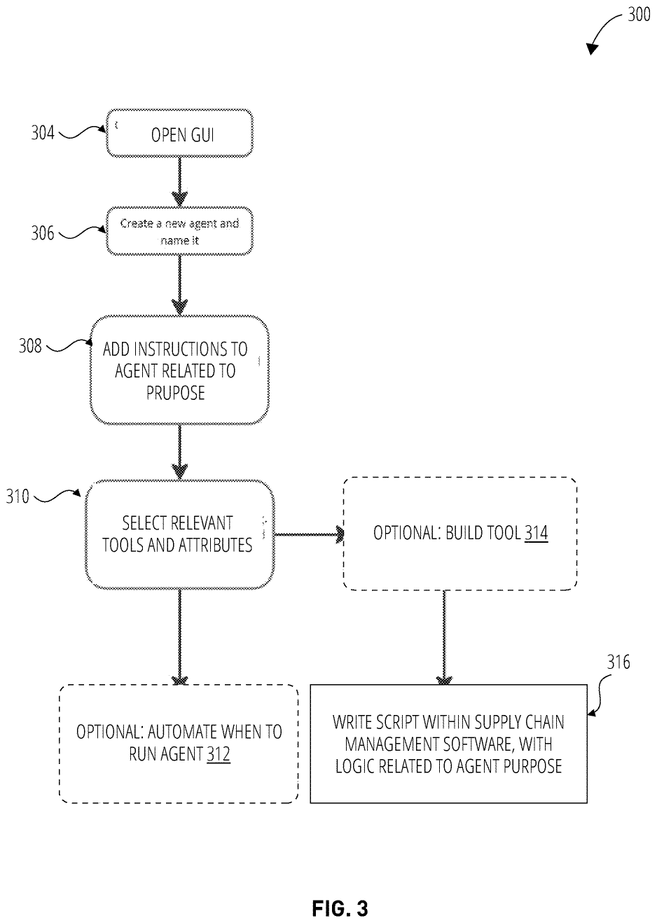

FIG. 3 illustrates a block diagram 300 for constructing an agent, in accordance with one embodiment.

A planner can author an agent via an automation framework. This is integrated within a graphical user interface (GUI) of a supply chain management software. The planner can start from a template (e.g. a ready-made agent) or from scratch. GUI integration is advantageous in that it provides a seamless and intuitive experience for planners, allowing them to interact with the agent without switching platforms. The following UI components can be included in the interface to facilitate interaction with the agent: an agent builder, which includes text boxes for instructions and description; drop downs for selecting existing resources that the agent can use (for example, scripts, worksheets); a chat preview for testing the agent before publishing it; and debugging execution for viewing intermediate steps the agent has taken. The GUI can handle feedback from the planner during the problem-solving process by using, for example, a chat interface. The agent can adjust its actions based on each new planner message iteratively.

At 304, the GUI for authoring an agent, is opened. A new agent is created and named at 306. Next, at 308, instructions related to a purpose of the agent. Such instructions can be added using natural language. That is, the agent's attributes can include natural language instructions (written by the planners, to explain its purpose and how to solve a specific set of problems).

Planners can use natural language to explain how they solve problems, which is used to condition an agent. This is advantageous in that it enables the system to understand and replicate human decision-making processes, reducing the need for manual repetition. The natural language input is processed and converted into actionable instructions for the agent. As an example, an LLM can convert the natural language description into a series of script calls so that the agent can execute those scripts and provide results. There are mechanisms that can ensure the accuracy of the agent's interpretation of the planner's instructions. For example, the agent can confirm script execution with the planner before proceeding. The instructions and scripts can include options to verify results are as expected and continue iterating until success conditions are met. In some embodiments, the system can handle multiple languages or dialects in the input, since LLMs naturally can handle different languages.

Next, at 310, one or more relevant tools, along with their respective attributes, can be selected. The tools can be selected from a repository. As an example, a tool called “read worksheet” can be selected; its attribute can include which worksheets the tool is allowed to read. If no tool from the repository seems relevant, there is an option, at 314, to build a tool. The tools typically have an input/output structure and rely on resources to be executed. For example, a tool may be a script that takes in the data from a worksheet that show the relationship between finished goods and their parts, and outputs a list of parts sorted by the amount of late revenue associated with their finished goods.

Next at 316, whether tools are selected from a repository (310) or built (314), a script is written, for example, with a code editor, within the supply chain management software. The script has logic applicable to the purpose of the agent. In addition the script can have access to a variety of functions that enable it to control the supply chain management software. Finally, at 312. there is an option to automate when to run the agent on a schedule, or via trigger rules. Without automation, the agent can be invoked via a chat interface by a use who has access to the agent.

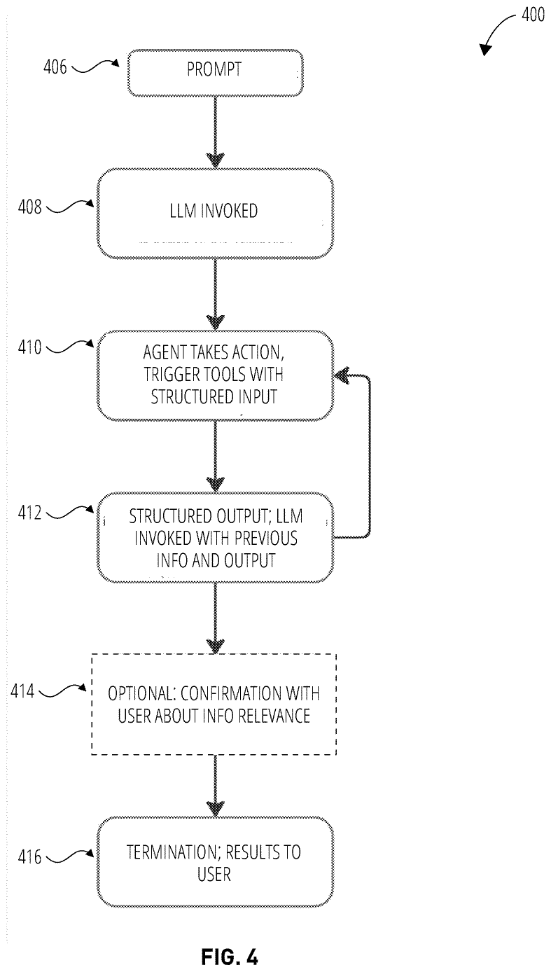

FIG. 4 illustrates a block diagram 400 of a workflow for an agent, in accordance with one embodiment.

At 406, a prompt is received or seen by the agent. At 408, the agent invokes a large language model and can take on the prompt, instructions and resource description to decide on the next action. Next, at 410, the agent can take as many actions as deemed relevant by the agent, and can trigger tools with structured input. With respect to taking actions, the agent has some guardrails established by the planners. At 412, the tools provide structured output, which can be read by the agent, which then invokes again a LLM wit the previous information and adds the structured output to that information. Optionally, at 414, the agent can communicate back to the user to confirm that the actions take are relevant. Finally at 416, the agent terminates itself and allows a user to see the results.

The agent can invoke tools, analyze their outputs, and chain them together based on an initial prompt. This allows for complex problem-solving by combining multiple tools in a logical sequence, mimicking human decision-making. Examples of tools that are available for an agent to invoke, include worksheets and scripts. Worksheets are customized reports that contain business semantics (for example, revenue at risk); the agent can run queries on top of this report data (for example: what are the top 5 orders with the highest revenue at risk?). Scripts are also customized, they can be JavaScript code that runs within supply chain software platform and have access to objects and functions in that platform (for example: get this data, create scenario, edit data, send message, etc.).

The agent can determine which tools to chain together for a given problem as follows. The LLM determines which tools are best to use depending on the user prompt and the instructions built into the agent by its author. The agent also sees metadata related to the worksheets and scripts to understand what they are used for and how to use them (for example: names of columns in worksheets, column descriptions, worksheet help, column data types, script description, script arguments and their descriptions, etc.).

There can be a feedback loop to improve tool selection and chaining over time. The LLM can course correct within a conversation. For example, if a tool gives an error message it can try the tool again taking into account what went wrong last time, or if feedback was given by the user earlier in the conversation it will keep that in mind while using future tools.

The agent has the ability to invoke a large language model which provides both structured output and input for tools in accordance with instructions. The agent can interact with a planner/user when required via chat capabilities. Given this ability, an agent can decide what tools are most useful among the tools that it is allowed to access and how to chain the tools together, given an initial prompt and its own outputs. Continuing the example from above, if the agent finds that no late revenue is found for the finished goods shown in the worksheet, then it will terminate. However, if some late revenue is found across ten parts and there is one part in particular whose impact is much larger than others, then the agent may prioritize that part and continue to solve the problem by indicating how that part requires a solution and will output relevant information about that part in particular.

This example demonstrates that a tool can be a traditional software piece, but that uses of the tool are determined by the agent. Thus, the agent determines what are the relevant inputs, and outputs from the tool are analyzed by the agent so that:
(1) Planners can see the steps in action and decision points that agents act upon.
(2) The agent itself may call other tools to continue the solution process.
(3) Other agents may pick up the output and continue the solution process.

As for point 3, there is no distinguishing between a set of agents working together to solve a problem (agent A with one specific subtask, agent B with a different subtask, with A and B acting in sequence to solve the whole task) or a single agent acting by itself across all steps, since the systems and methods disclosed herein allow for both cases (that is, there can be one more general agent orchestrate multiple very specific agents).

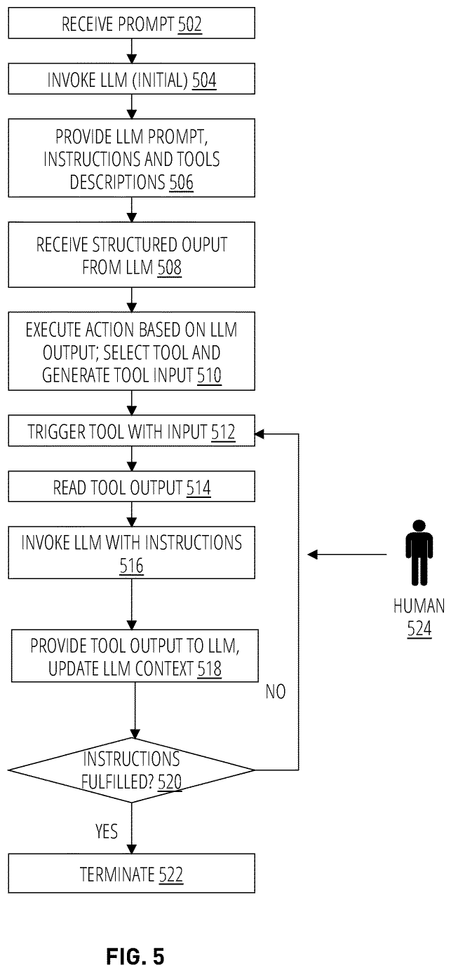

FIG. 5 illustrates a block diagram of a workflow for an agent, in accordance with one embodiment.

In summary, an agent's workflow can include a loop of: (1) interpret, followed by: (2) act via tools, followed by: (3) read results; and (4) re-interpret, until the task is done. Another example of a workflow is described below.

Before runtime, there is authoring/setup of an agent. A planner can author an agent in the supply chain management software's GUI (from a template or from scratch). The agent can be defined by: natural-language instructions (which includes a purpose of the agent and how to solve a class of problems), and a set of tools/resources that the agent is allowed to use. Each tool has structured inputs/outputs. An example of authoring or setting up an agent is illustrated in FIG. 3.

Once the agent is set, there is a trigger, at which point runtime starts. The agent receives a prompt. For example, this can include a planner request or a detected planning issue.

Following the trigger, there is a reasoning step with an LLM. This includes invoking the LLM by the agent, which provides the LLM with the prompt, instructions from the agent, and resource/tool descriptions (that is, what tools exist and their respective schemas). The LLM subsequently returns a structured output telling the agent what to do next. As an example, this can include instructing the agent which tool to call and with what inputs, or what action to take.

Once the LLM provides instructions to the agent, an execution step follows, that includes tools and steps. The agent executes an action based on that structured output. Then, iteratively, the agent triggers a tool with a structured input (which was generated/filled by the LLM) to the tool; reads the tool's structured output; invokes the LLM again with the instructions (and now also the tool output); and adds the tool output into context, so the LLM can decide the next step.

At this juncture, there are decision points and optional communication with the planner. For example, the agent can terminate early if results indicate that there nothing to do (as an example, no late revenue found). Or, if results indicate an issue, the agent can prioritize and continue (as an example: focus on a part with outsized impact). When needed, the agent can interact with the planner via chat (for example to confirm which scenario/solution is best).

A block diagram of a workflow for an agent, in accordance with one embodiment, is illustrated in FIG. 5.

At the outset, an agent has been defined. For example, see FIG. 3 of a block diagram 300 for constructing an agent by a planner. The agent can be created from a template or from scratch. In addition, the agent includes (i) natural-language instructions describing purpose and approach and (ii) an allowed set of tools/resources with defined structured inputs/outputs.

At block 502, the agent receives a prompt. This can be, for example, a user request or detected planning issue, that starts an execution run. At block 504, the agent initially invokes a large language model (LLM) and at block 506, provides the prompt, the agent instructions, and one or more resource/tool descriptions. At block 508, the LLM outputs a first structured output indicating a next action. For example, this can include selecting a tool and generating a structured input for the tool. AT block 510. the agent executes an action based on the first structured output. For example, this action can include selecting a tool and generating a structured input for the tool. At block 512, the agent triggers a selected tool using the structured input. At block 514, the agent reads a respective structured output from the tool. For example, this can include ranked parts, detected anomalies, or recommended parameter changes. Next, at block 516, the agent invokes the LLM again with the agent instructions and adds the tool output to the LLM context (block 518).

There is a decision/branch at decision block 520, based on the updated context. Here, the LLM outputs an additional structured output that causes the agent to terminate when the set of instructions are fulfilled (‘yes’ at decision block 520). Or LLM outputs an additional structured output that causes the agent to iteratively return to block 512 until it terminates at 522. The iteration can include, for example, (a) call to another tool, (b) prioritization a subset of issues, (c) generation of candidate scenarios/solutions or (d) request of additional information.

In addition, there can be a human-in-the-loop (524). The agent can interact with the planner via chat or the GUI to confirm a solution (e.g., selecting among candidate scenarios) or to obtain missing information, and then continues the iterative loop as needed.

In some embodiments, an orchestrator agent can delegate subtasks to one or more worker agents, receive their outputs, and either continue tool/LLM iterations or return a final result.

Thee run ends when the agent determines that the instructions are fulfilled (or that no action is required), and it outputs the results and/or selected scenario(s) for planner review.

This example demonstrates that a tool can be a traditional software piece, but that uses of the tool are determined by the agent. Thus, the agent determines what are the relevant inputs, and outputs from the tool are analyzed by the agent so that:

Planners can see the steps in action and decision points that agents act upon.

The agent itself may call other tools to continue the solution process.

Other agents may pick up the output and continue the solution process.

As for point 3, there is no distinguishing between a set of agents working together to solve a problem (agent A with one specific subtask, agent B with a different subtask, with A and B acting in sequence to solve the whole task) or a single agent acting by itself across all steps, since the systems and methods disclosed herein allow for both cases (that is, there can be one more general agent orchestrate multiple very specific agents).

In addition to the above, there is an option for multi-agent orchestration. That is, the “agent” can be a single agent that executes all steps, or there can be an orchestrator agent that delegates subtasks to specialized worker agents, then returns results/asks for more information if needed.

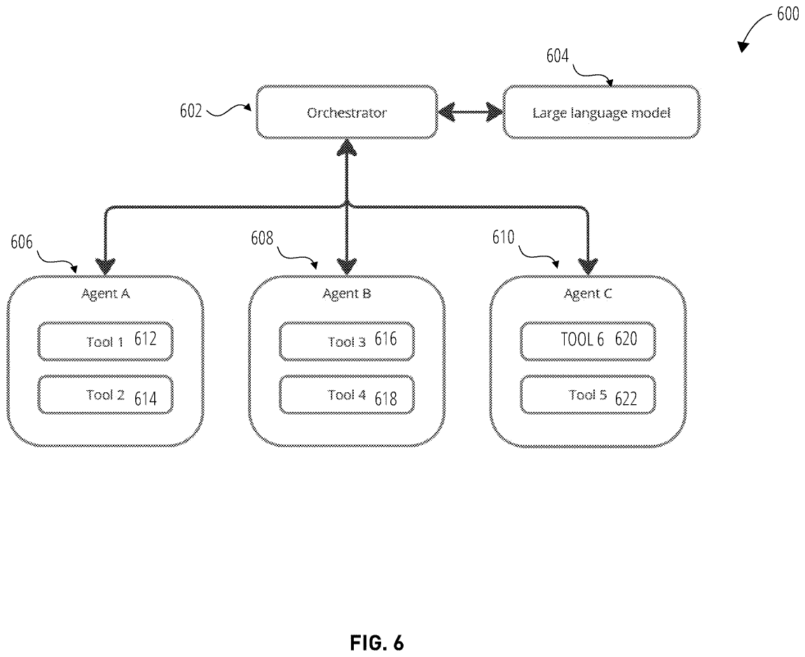

FIG. 6 illustrates an orchestration layer 600 in accordance with one embodiment. Orchestrator agent 602 interacts with LLM 604. For example, it initially invokes LLM 604, providing it with prompts, instructions and tools descriptions (as in, for example, block 506 of FIG. 5), receives structured output from the LLM 604, and executes actions based on the structure output of the LLM 604, and iteratively interacts with the LLM 604 until termination. However, orchestrator agent 602 delegates subtasks to specialized worker agents: Agent A 606, Agent B 608 and Agent C 610. In FIG. 6, Agent A 606 is assigned to work with Tool 1 612 and Tool 2 614; Agent B 608 is assigned to work with Tool 3 616 and Tool 4 618; and Agent C 610 is assigned to work with Tool 5 622 and Tool 6 620.

As shown in FIG. 6, the system can include an orchestration layer where multiple agents work together to solve a problem. This enables collaborative problem-solving by distributing tasks among specialized agents, improving scalability and performance.

Agents can be assigned roles or responsibilities within the orchestration layer as follows. Planners can give agents roles and responsibilities by providing instructions. Any agent with subagents is automatically given the role of being able to handoff control to another agent. Communication protocols used between agents during collaboration can include handoff, where one agent will hand over an entire conversation history to the next agent.

### Examples

An example of a predefined context given to the LLM for an orchestrator agent can include the following:

“You are an orchestrator agent for a supply chain management software. You are responsible for delegating tasks to the appropriate worker agents you have at your service. Absolutely all of your replies should either be the worker agent to use, or a summary of the results if you believe there's no worker agent to call e.g. a task is complete, or you need more information from the user before you can call the worker agents.”

An example of additional dynamic context given a task requiring data from a worksheet can include the following: “The user is looking at the Demand Orders worksheet in the Planning workbook. Here is the schema for this worksheet”

With respect to tools, tools can be:
a) domain specific such as a demand anomaly analysis tool, wrapping complex operations about data access and computations and flagging finished goods that require attention.
b) generic such as a worksheet manipulation tool, reading the columns of data as is.
c) action-oriented, such as a safety stock adjustment tool, abstracting data model knowledge to modify input data and suggesting new plans automatically.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing a first set of instructions that, when executed by the processor, configure the apparatus to:
maintain an agent definition comprising a second set of instructions authored by a user and authorization to access a set of resources each having a respective schema defining input and output;
receive a prompt indicative of a planning problem;
generate, using a Large Language Model conditioned on the prompt, the second set of instructions, and the schemas, an action specification that identifies at least one authorized resource and corresponding input for the at least one authorized resource;
cause execution of the at least one authorized resource with the input to obtain output;
update, based on the output, context provided to the LLM to generate a subsequent action specification until a completion condition is satisfied; and
output, for presentation to the user, a proposed resolution of the planning problem derived from at least one said output.

2. The computing apparatus of claim 1, wherein the second set of instructions comprise natural-language instructions.

3. The computing apparatus of claim 1, wherein the resources comprise software tools selected from a repository.

4. The computing apparatus of claim 1, wherein the schema for each resource is version controlled in a database.

5. The computing apparatus of claim 1, wherein the first set of instructions further configure the apparatus to receive user feedback via a graphical user interface and updating the agent definition based on the feedback.

6. The computing apparatus of claim 1, wherein the action specification includes chain multiple resources together in sequence or in parallel.

7. The computing apparatus of claim 1, wherein the agent comprises an orchestration agent that delegates tasks to one or more worker agents and receives outputs from the worker agents to generate the proposed resolution.

8. A non-transitory computer-readable storage medium, the computer-readable storage medium including a first set of instructions that when executed by a computer, cause the computer to:
maintain an agent definition comprising a second set of instructions authored by a user and authorization to access a set of resources each having a respective schema defining input and output;
receive a prompt indicative of a planning problem;
generate, using a Large Language Model (LLM) conditioned on the prompt, the second set of instructions, and the schemas, an action specification that identifies at least one authorized resource and corresponding input for the at least one authorized resource;
cause execution of the at least one authorized resource with the input to obtain output;
update, based on the output, context provided to the LLM to generate a subsequent action specification until a completion condition is satisfied; and
output, for presentation to the user, a proposed resolution of the planning problem derived from at least one said output.

9. The computer-readable storage medium of claim 8, wherein the second set of instructions comprise natural-language instructions.

10. The computer-readable storage medium of claim 8, wherein the resources comprise software tools selected from a repository.

11. The computer-readable storage medium of claim 8, wherein the schema for each resource is version controlled in a database.

12. The computer-readable storage medium of claim 8, wherein the first set of instructions further configure the computer to receive user feedback via a graphical user interface and updating the agent definition based on the feedback.

13. The computer-readable storage medium of claim 8, wherein the action specification includes chain multiple resources together in sequence or in parallel.

14. The computer-readable storage medium of claim 8, wherein the agent comprises an orchestration agent that delegates tasks to one or more worker agents and receives outputs from the worker agents to generate the proposed resolution.

15. A computer-implemented method comprising:
maintaining an agent definition comprising instructions authored by a user and authorization to access a set of resources each having a respective schema defining input and output;
receiving a prompt indicative of a planning problem;
generating, using a Large Language Model (LLM) conditioned on the prompt, the instructions, and the schemas, an action specification that identifies at least one authorized resource and corresponding input for the at least one authorized resource;
causing execution of the at least one authorized resource with the input to obtain output;
updating, based on the output, context provided to the LLM to generate a subsequent action specification until a completion condition is satisfied; and
outputting, for presentation to the user, a proposed resolution of the planning problem derived from at least one said output.

16. The computer-implemented method of claim 15, wherein the instructions comprise natural-language instructions.

17. The computer-implemented method of claim 15, wherein the resources comprise software tools selected from a repository.

18. The computer-implemented method of claim 15, wherein the schema for each resource is version controlled in a database.

19. The computer-implemented method of claim 15, further comprising receiving user feedback via a graphical user interface and updating the agent definition based on the feedback.

20. The computer-implemented method of claim 15, wherein the action specification includes chaining multiple resources together in sequence or in parallel.

21. The method of claim 15, wherein the agent comprises an orchestration agent that delegates tasks to one or more worker agents and receives outputs from the worker agents to generate the proposed resolution.
